(19) United States
(12) Patent Application Publication
(10) Pub. No.: US 2022/0065281 A1
(43) Pub. Date: Mar. 3, 2022

(54) PLUMB ADJUSTER FOR ELECTRICAL ENCLOSURE

(71) Applicant: MILBANK MANUFACTURING CO., Kansas City, MO (US)

(72) Inventor: BRIAN HAGEN, RAYTOWN, MO (US)

(73) Assignee: MILBANK MANUFACTURING CO., KANSAS CITY, MO (US)

(21) Appl. No.: 17/011,510

(22) Filed: Sep. 3, 2020

(51) Int. Cl. F16B 23/00; F16B 39/30; H02G 3/10

(52) U.S. Cl. CPC F16B 23/0084; H02G 3/10; F16B 39/30

(57) ABSTRACT

A plumb adjuster configured to plumb an electrical enclosure mounted to a vertical or nearly vertical surface. The plumb adjuster includes a side wall with a threaded outer surface that is configured to engage a threaded surface of the electrical enclosure. The side wall defines a cavity accessible through a first opening at a first end that is configured to receive the head of a fastener for mounting the electrical enclosure to the surface. An end wall coupled to a second end of the side wall has an outer surface configured to engage the surface to which the electrical enclosure is mounted. The end wall has an inner surface configured to engage the head of the fastener. The end wall defines a second opening that extends through the end wall, and the second opening is configured to receive a shank of the fastener.

### CROSS-REFERENCE TO RELATED APPLICATIONS

Not applicable.

### BACKGROUND OF THE INVENTION

### 1. Field of the Invention

The invention is directed toward a plumb adjuster and, in particular, toward a plumb adjuster for use with an electrical enclosure.

### 2. Description of Related Art

Electrical enclosures, such as meter socket enclosures, junction boxes, panel mount enclosures, transformer cabinets, and telephone cabinets, are used to house electrical components and electrical wiring. An electrical enclosure that is designed for mounting to a vertical wall may include mounting locations or embosses that are stamped or otherwise formed in the back wall of the enclosure. A fastener is inserted through a hole in each of the mounting locations or embosses to mount the enclosure to the wall. If the wall is not perfectly or substantially vertical (i.e., the wall is not plumb), shims, blocks, or other items may be placed between the wall and certain of the mounting locations to space the electrical enclosure from the wall at those locations and achieve a plumb installation. If the electrical enclosure is not plumb when mounted, doors, covers, or front panels of the electrical enclosure may not operate properly.

While the use of shims may allow an installer to achieve a substantially plumb installation, when one or more shims is used, multiple lengths of fasteners may be required to mount the enclosure to the wall. For example, if a large shim is placed behind one corner of the enclosure, a longer fastener may be necessary to mount the enclosure at that corner and still achieve the desired depth of engagement between the fastener and the wall to which the enclosure is mounted. Thus, when shims are used, the installer may need to locate and carry multiple lengths of fasteners in order to mount the electrical enclosure to the wall. Further, when shims are used, it may be difficult for a single installer to hold the enclosure and shims in place while also driving the fasteners through the enclosure and into the wall. In addition, it may be difficult when using shims to adjust the shims into the necessary position to achieve a plumb installation. The installer may need to back out the fasteners and adjust the shims multiple times in order to plumb the enclosure as desired.

### BRIEF SUMMARY OF THE INVENTION

One embodiment of the invention is directed toward a plumb adjuster configured to plumb an electrical enclosure mounted to a vertical or nearly vertical surface. The electrical enclosure has a wall with an opening therethrough and a threaded surface adjacent the opening. The plumb adjuster includes a side wall with a threaded outer surface that is configured to engage the threaded surface of the electrical enclosure. The side wall has a first end and a second end, and the side wall defines a cavity accessible through a first opening at the first end. The first opening is configured to receive the head of a fastener for mounting the electrical enclosure to the surface. The plumb adjuster further includes an end wall coupled to the second end of the side wall. The end wall has an outer surface configured to engage the surface to which the electrical enclosure is mounted. The end wall has an inner surface configured to engage the head of the fastener. The end wall defines a second opening that extends through the end wall, and the second opening is configured to receive a shank of the fastener. The plumb adjuster may allow a single installer to install an electrical enclosure with relative ease, in a plumb manner, and without the use of shims. The plumb adjuster may also eliminate the need to carry multiple lengths of fasteners to mount the enclosure to a surface.

In some embodiments, the side wall is operable to rotate so that the engagement between the threaded outer surface of the side wall and the threaded surface of the electrical enclosure moves the end wall with respect to the wall of the electrical enclosure and adjusts the distance between the wall of the electrical enclosure and the surface to which the electrical enclosure is mounted.

In some embodiments, the outer surface of the plumb adjuster end wall is convex.

In some embodiments, the threaded outer surface of the plumb adjuster side wall is formed as a multi-start thread.

In some embodiments, the plumb adjuster includes a tool engagement portion that is formed as part of the side wall or coupled to the side wall adjacent the first end. The tool engagement portion may be configured for engagement by a socket or wrench for rotating the side wall.

Another embodiment of the invention is directed toward an electrical enclosure configured for mounting to a vertical or nearly vertical surface. The electrical enclosure includes an enclosure wall with an opening therethrough and a threaded surface adjacent the opening. The electrical enclosure further includes a plumb adjuster as described above configured to receive a fastener for mounting the electrical enclosure to the vertical or nearly vertical surface.

In some embodiments, the enclosure wall defines a second opening that is spaced from the opening of the enclosure wall. The second opening of the enclosure wall is configured to receive a portion of a second fastener for mounting the enclosure wall to the vertical or nearly vertical surface. A thickness of the enclosure wall adjacent the second opening of the enclosure wall is substantially the same as a thickness of the end wall of the plumb adjuster.

Another aspect of the invention is directed toward a method of mounting an electrical enclosure to a vertical or nearly vertical surface with a plumb adjuster as described above that engages a threaded surface of a wall of the enclosure. The method includes engaging the outer surface of an end wall of the plumb adjuster with the vertical or nearly vertical surface; rotating the plumb adjuster to move the end wall with respect to an enclosure wall of the electrical enclosure and adjust the distance between the enclosure wall and the vertical or nearly vertical surface until the enclosure wall is substantially plumb or vertical; inserting a fastener through a first opening of the plumb adjuster; inserting a shank of the fastener through a second opening of the plumb adjuster; and engaging the shank of the fastener with the vertical or nearly vertical surface to mount the enclosure wall to the vertical or nearly vertical surface.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

Various exemplary embodiments of the present invention are described in detail below with reference to the attached drawing figures, wherein:

FIG. 1 is a front elevational view of an electrical enclosure with plumb adjusters in accordance with one exemplary embodiment of the invention described herein, showing the electrical enclosure mounted to a nearly vertical surface;

FIG. 2 is a cross-sectional view taken through the line 2-2 of FIG. 1;

FIG. 3 is a front elevational view of the electrical enclosure shown in FIG. 1;

FIG. 4 is a rear perspective view of the electrical enclosure shown in FIG. 1;

FIG. 5 is a detail view of an opening and threaded surface in a rear wall of the electrical enclosure shown in FIG. 1;

FIG. 6 is a perspective view of one of the plumb adjusters of the electrical enclosure shown in FIG. 1;

FIG. 7 is a front elevational view of the plumb adjuster shown in FIG. 6;

FIG. 8 is a cross-sectional view taken through the line 8-8 of FIG. 7;

FIG. 9 is a side elevational view showing a threaded outer surface of the plumb adjuster engaging the threaded surface of the rear wall shown in FIG. 5;

FIG. 10 is a cross-sectional view taken through the line 10-10 of FIG. 9;

FIG. 11 is a front elevational view showing the plumb adjuster engaged with the rear wall shown in FIG. 5 and a fastener extending through the plumb adjuster to mount the rear wall of the electrical enclosure to the nearly vertical surface;

FIG. 12 is a cross-sectional view taken through the line 12-12 of FIG. 11; and

FIG. 13 is a rear perspective view of an alternative embodiment of an electrical enclosure with plumb adjusters in accordance with the invention described herein.

### DETAILED DESCRIPTION OF PREFERRED EMBODIMENT

The present invention is directed to a plumb adjuster configured to plumb an electrical enclosure mounted to a vertical or nearly vertical surface, an electrical enclosure including a plumb adjuster, and a method of mounting an electrical enclosure to a vertical or nearly vertical surface with a plumb adjuster. While the present invention will be described in detail below with reference to various exemplary embodiments, it should be understood that the invention is not limited to the specific configurations of these embodiments. In addition, although the exemplary embodiments are described as embodying several different inventive features, one skilled in the art will appreciate that any one of these features could be implemented without the others in accordance with the present invention.

### 1. First Exemplary Embodiment of Electrical Enclosure

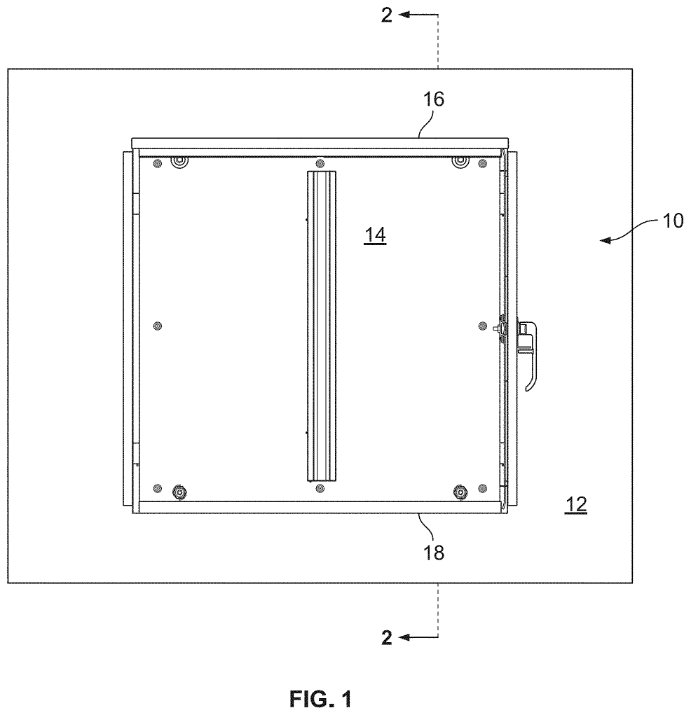

An electrical enclosure in accordance with an exemplary embodiment of the invention described herein is identified generally as 10 in FIG. 1. The electrical enclosure 10 is shown mounted to a surface 12 that is nearly vertical. The electrical enclosure 10 includes a rear wall 14 that is mounted to the surface 12. The electrical enclosure 10 may be any type of electrical enclosure including, but not limited to, a meter socket enclosure, a junction box, a pull box, a panel mount enclosure, a transformer cabinet, and a telephone or other utility cabinet. The electrical enclosure 10 may be designed for indoor use or may be designed for outdoor use, e.g., the electrical enclosure 10 may be a NEMA Type 3R rated enclosure.

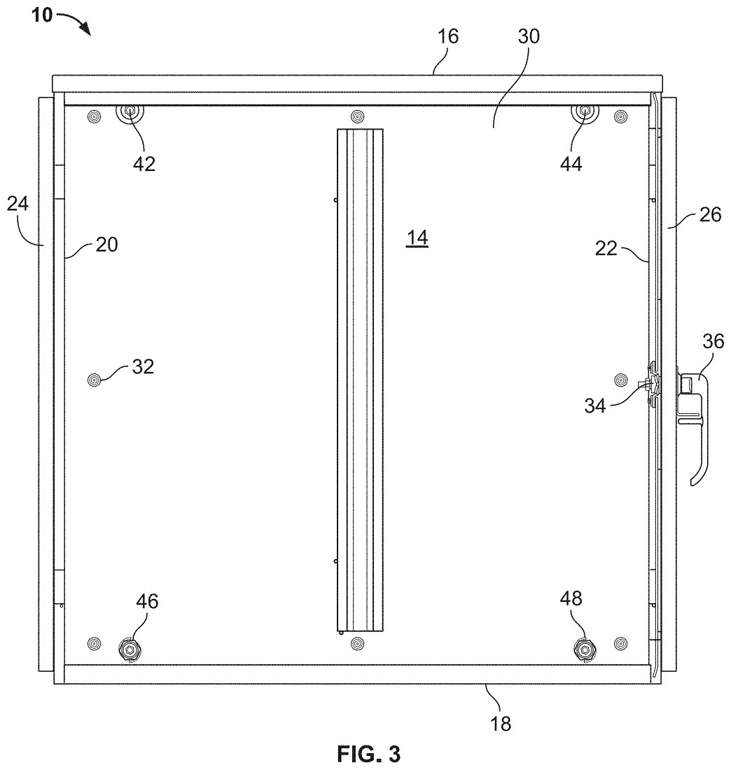

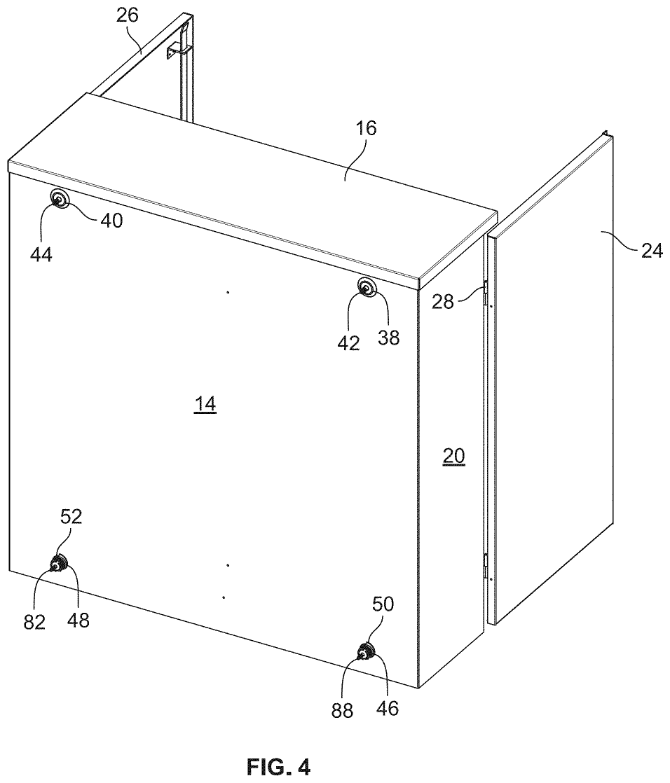

Referring to FIG. 3, a top wall 16, a bottom wall 18, and side walls 20, 22 of the electrical enclosure 10 each extend outward from the rear wall 14. The top wall 16, bottom wall 18, and side walls 20, 22 may be integral with rear wall 14 and formed by bending portions of an enclosure blank. Alternatively, any of the top wall 16, bottom wall 18, and side walls 20, 22 may be secured to rear wall 14 by any suitable attachment means, such as by spot welding, fasteners, or the like. Doors 24 and 26, best shown in FIG. 4, are connected to side walls 20 and 22, respectively, with hinges, one of which is identified as 28 in FIG. 4. The doors 24 and 26 are movable between the open position shown in FIG. 4 and a closed position, not shown, in which the doors 24 and 26 cover the interior space 30 (FIG. 3) defined by the rear wall 14, top wall 16, bottom wall 18, and side walls 20, 22. Electrical components (not shown) may be mounted to the rear wall 14 within the interior space 30 using panel mounts 32 or any other suitable means known in the art. The electrical enclosure 10 may further include knockouts (not shown) for running electrical conduit in and out of the interior space 30. The door 26 includes a latch mechanism 34, which can be operated with a handle 36 to secure the doors 24 and 26 together and to the top wall 16 and bottom wall 18 when the doors 24 and 26 are closed. A padlock (not shown) may be used to lock the latch mechanism 34 in a closed position to prevent tampering with the electrical components mounted in the interior space 30. In lieu of doors 24 and 26, the electrical enclosure 10 may include a cover (not shown) that attaches to one or more of the top wall 16, bottom wall 18, and side walls 20, 22 with, for example, screws.

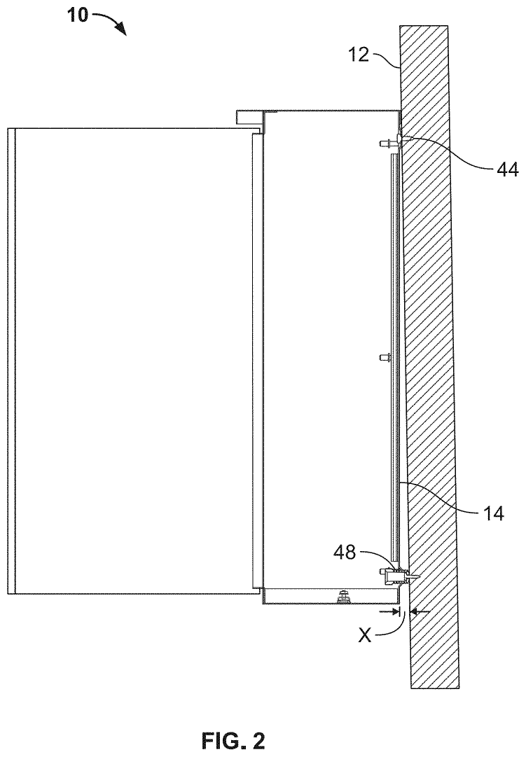

As shown in FIG. 4, the rear wall 14 includes mounting embosses 38 and 40 that extend slightly rearward from the remainder of the rear wall 14. Mounting emboss 38 is positioned in an upper right-hand corner of rear wall 14 when viewing the back of the enclosure as shown in FIG. 4, and mounting emboss 40 is positioned in an upper left-hand corner of rear wall 14. Fasteners 42 and 44 are shown in FIG. 4 extending through openings formed in the mounting embosses 38 and 40, respectively. The fasteners 42 and 44 are used to mount the rear wall 14 of the electrical enclosure 10 to the surface 12, as shown in FIG. 2 with respect to fastener 44. The fasteners 42 and 44 may be, for example, lag screws, or any other suitable fastener depending on the type of material to which the electrical enclosure 10 is mounted. When fasteners 42 and 44 mount rear wall 14 to surface 12, the mounting embosses 38 and 40 abut the surface 12.

Plumb adjusters 46 and 48, shown in FIG. 4, are coupled to the rear wall 14 as described in more detail below for mounting the electrical enclosure 10 to the surface 12 so that the rear wall 14 is plumb or substantially vertical. Plumb adjuster 46 engages a threaded surface 50 of rear wall 14 at a lower right-hand corner of rear wall 14, when viewed as shown in FIG. 4, and plumb adjuster 48 engages a threaded surface 52 of rear wall 14 at a lower left-hand corner of rear wall 14.

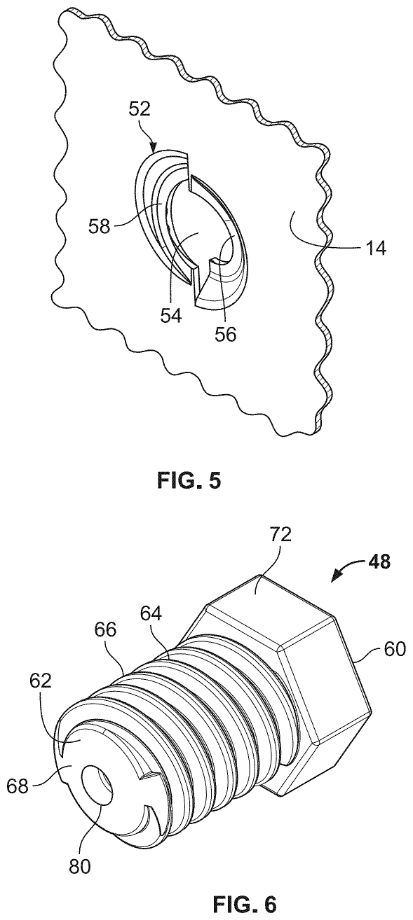

The threaded surface 52 of rear wall 14 is shown in more detail in FIG. 5. The threaded surface 52 surrounds an opening 54 extending through the rear wall 14. The threaded surface 52 is formed as a double-start thread having a first partial helical surface 56 and a second partial helical surface 58. The threaded surface 50 of rear wall 14 has substantially the same structure as the threaded surface 52 shown in FIG. 5.

Plumb adjuster 48 is shown in more detail in FIGS. 6-8. The plumb adjuster 48 has a first end 60 and a second end 62. A side wall 64 having a threaded outer surface 66 extends from adjacent the first end 60 to the second end 62. The threaded outer surface 66 is formed as a double-start thread that is configured to engage the threaded surface 52 of rear wall 14. An end wall 68 is integrally formed with the side wall 64 at the second end 62. The end wall 68 has an outer surface 70 that is convex or dome-shaped, as best shown in FIG. 8. The convex shape of the outer surface 70 allows the outer surface 70 to effectively engage a surface that is not perfectly vertical to space the rear wall 14 from the non-vertical surface so that the rear wall 14 is substantially vertical. A tool engagement portion 72 of the plumb adjuster 48 is formed as part of the side wall 64 or coupled to the side wall 64 adjacent the first end 60. The tool engagement portion 72 is shown as a hex head, which is configured to be engaged by a socket or wrench for rotating the plumb adjuster 48.

The side wall 64 of plumb adjuster 48 defines a cavity 74, shown in FIG. 8, that is accessible through a first opening 76 extending through the tool engagement portion 72 at the first end 60. The end wall 68 has an inner surface 78 facing the cavity 74. A second opening 80 extends through the end wall 68. The second opening 80 has a smaller diameter than the first opening 76 and the diameter of the cavity 74. Plumb adjuster 46 has substantially the same structure as plumb adjuster 48.

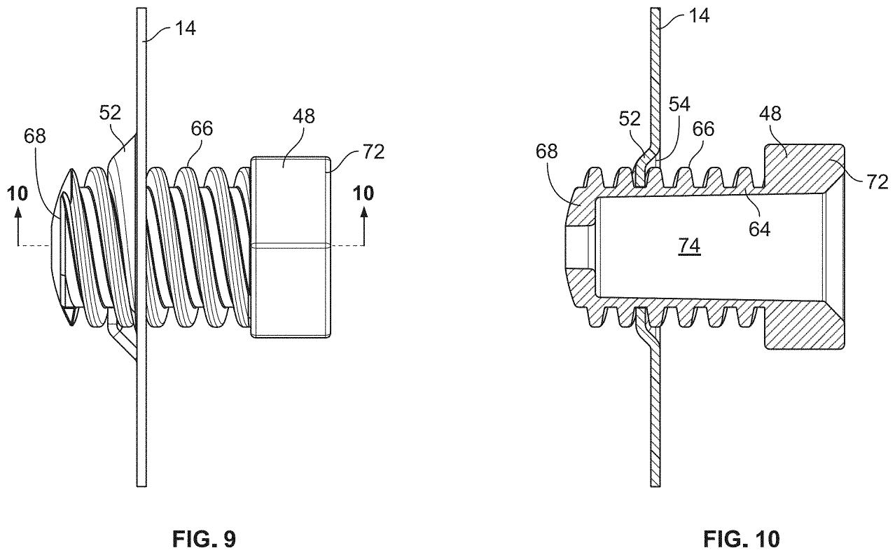

The threaded outer surface 66 of plumb adjuster 48 is configured to engage the threaded surface 52 of rear wall 14, as shown in FIGS. 9 and 10, with a portion of the plumb adjuster 48 extending through the opening 54 in rear wall 14. As described above, both the outer threaded surface 66 and the threaded surface 52 are formed as double start threads. The use of double start threading provides two contact points between the threaded surfaces 52 and 66 to spread the load transferred between the surfaces and reduce backlash. Further, the double start threading provides a secure engagement between the threaded surfaces 52 and 66 while minimizing the depth of the threaded surface 52 relative to the depth that would be necessary to provide secure engagement with a single start thread. In other words, the threaded surface 52 does not need to extend a great distance forward or rearward from the remainder of the rear wall 14 to provide a secure engagement between the threaded surfaces 52 and 66. It is within the scope of the invention, however, for the threaded surfaces 52 and 66 to be single start threads or any type of multi-start threads.

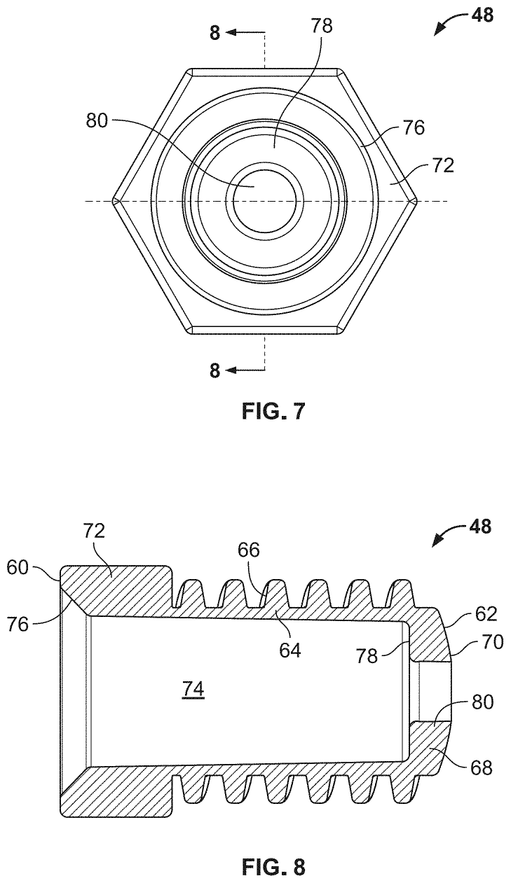

The tool engagement portion 72 of the plumb adjuster 48 may be engaged with a wrench or socket and rotated to move the end wall 68 toward or away from the rear wall 14. For example, the plumb adjuster 48 may be rotated in a clockwise direction, when viewing plumb adjuster 48 as shown in FIG. 7, to increase the distance between the end wall 68 and the rear wall 14. Further, the plumb adjuster 48 may be rotated in a counter-clockwise direction, when viewed as shown in FIG. 7, to decrease the distance between the end wall 68 and the rear wall 14. Although tool engagement portion 72 is shown as a hex head, other types of tool engagement portions 72 are within the scope of the invention. For example, the tool engagement portion 72 may be a surface designed for grasping by a user's fingers for rotation, an internal hex surface formed in side wall 64 surrounding cavity 74, a pair of external, opposed planar sides designed for engaging a wrench, or any other suitable structure.

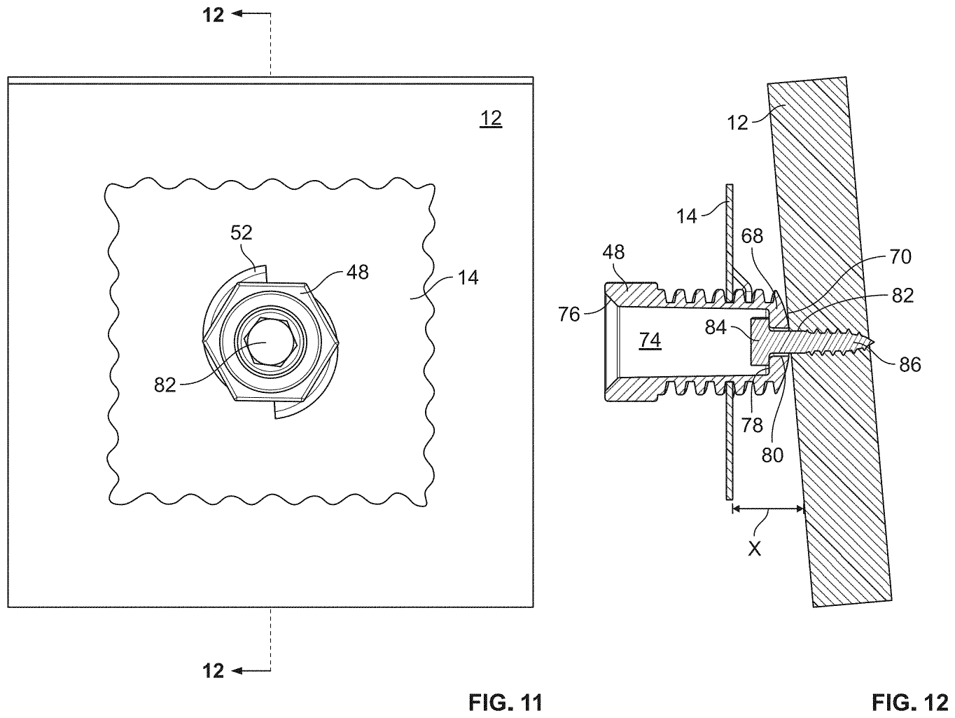

FIGS. 11 and 12 show a fastener 82 extending through plumb adjuster 48 to mount rear wall 14 to surface 12. The fastener 82 has a head 84 and a shank 86 with threads to engage the surface 12. The first opening 76 of plumb adjuster 48 and the cavity 74 are sized to receive the head 84 of fastener 82, and a portion of a tool for rotation of the fastener 82, to allow an installer to rotate the fastener 82 for engagement with the surface 12. The second opening 80 of plumb adjuster 48 is sized to receive the shank 86 of the fastener 82 allowing the shank 86 to extend through the end wall 68 and into the surface 12. The second opening 80 is also sized smaller than the head 84 of the fastener 82 so that the head 84 engages the inner surface 78 of the end wall 68 when the fastener 82 is fully engaged with the surface 12. Another fastener 88, shown in FIG. 4, that is substantially similar to fastener 82 extends through plumb adjuster 46 in the same manner as described above with respect to fastener 82 to mount rear wall 14 to surface 12.

The thickness of the end wall 68 of plumb adjuster 48 from the inner surface 78 to the outer surface 70 may be substantially the same as the thickness of the rear wall 14 of the enclosure at the mounting embosses 38 and 40 (FIG. 4), i.e., the thickness of the rear wall 14 through which the fasteners 42 and 44 extend. This allows the fasteners 82 and 88 to have the same length as the fasteners 42 and 44 with all of the fasteners 42, 44, 82, and 88 having substantially the same depth of engagement with the surface 12, i.e., each of the fasteners 42, 44, 82, and 88 extends substantially the same depth into the surface 12. The fasteners 82 and 88 may thus be the same as the fasteners 42 and 44, which simplifies manufacture and installation of the electrical enclosure 10 in that the electrical enclosure 10 may be provided with four identical fasteners each of which may be used interchangeably for any of the four mounting locations.

As shown in FIG. 12, the outer surface 70 of plumb adjuster 48 extends a distance away from the rear wall 14 of electrical enclosure 10 to space the rear wall 14 from the surface 12. By spacing the rear wall 14 of the electrical enclosure 10 from the surface 12, the rear wall 14 is maintained in a vertical or substantially vertical orientation even when the surface 12 is not perfectly vertical. There is a non-zero angle X formed between the vertical rear wall 14 and the non-vertical surface 12 when the electrical enclosure 10 is securely mounted to the surface 12 such that the head 84 of the fastener 82 engages the inner surface 78 clamping the end wall 68 between the head 84 and the surface 12. As shown in FIG. 2, the upper portion of rear wall 14 through which fastener 44 extends abuts the surface 12 while plumb adjuster 48 spaces the lower portion of rear wall 14 from the surface 12 to maintain the rear wall 14 in a vertical or substantially vertical orientation when the electrical enclosure 10 is mounted.

To install electrical enclosure 10, an installer may first determine a desired height for installation on surface 12 and mark on surface 12 the locations where fasteners 42, 44, 82, and 88 will be inserted into the surface 12 ensuring that the electrical enclosure 10 will be level or substantially level when mounted. Surface 12 may be pre-drilled at the marked locations. The electrical enclosure 10 may be placed against the surface 12, and the fasteners 42 and 44 may be driven through the mounting embosses 38 and 40, respectively, and into the surface 12 to mount an upper portion of the electrical enclosure 10 to the surface 12.

The plumb adjuster 48 is then positioned so that the outer surface 70 of the plumb adjuster 48 engages the surface 12. The installer engages a tool with the tool engagement portion 72 of plumb adjuster 48 and rotates the plumb adjuster 48 in either the clockwise or counter-clockwise direction as necessary to plumb the rear wall 14 of the electrical enclosure 10. Plumb adjuster 46 is adjusted in the same manner as described above with respect to plumb adjuster 48 while checking the plumb of the electrical enclosure 10. When the installer determines that the rear wall 14 of the electrical enclosure 10 is vertical or substantially vertical, the fastener 82 is inserted through the plumb adjuster 48 and driven into the surface 12 until the head 84 of the fastener 82 engages the inner surface 78 of the plumb adjuster 48 as shown in FIG. 12. The fastener 88 is inserted through the plumb adjuster 46 and driven into the surface 12 in the same manner.

The plumb adjusters 46 and 48 thus simplify installation of the electrical enclosure 10 by eliminating the need for shims to achieve a plumb installation. The plumb adjusters 46 and 48 may be pre-threaded into the rear wall 14 of the electrical enclosure 10 prior to installation so that the installer does not need to locate them during installation. The plumb adjusters 46 and 48 further allow an installer to more precisely plumb the electrical enclosure 10 versus the use of shims because the plumb adjusters 46 and 48 allow for a near infinite range of adjustment along the length of the threaded outer surface 66. This makes it easier for the installer to adjust the fitment of doors 24 and 26 to ensure that they open, close, and latch properly.

### 2. Second Exemplary Embodiment of Electrical Enclosure

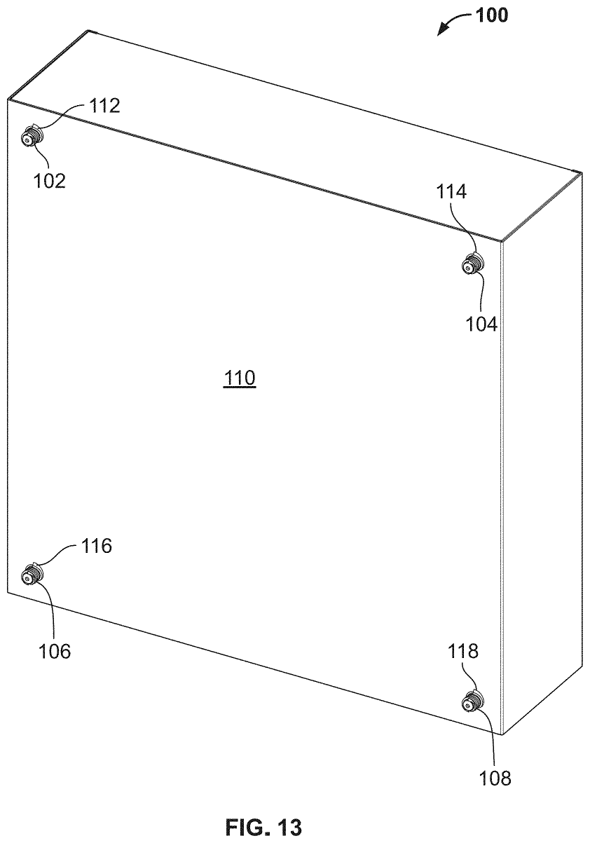

FIG. 13 shows an alternative embodiment of electrical enclosure 100 that is configured for use with four plumb adjusters 102, 104, 106, and 108. Other than the differences described below, electrical enclosure 100 is substantially the same as the electrical enclosure 10 described above and shown in FIGS. 1-4. Electrical enclosure 100 has a rear wall 110 with four threaded surfaces 112, 114, 116, and 118 each surrounding an opening extending through the rear wall 110. Each of the threaded surfaces 112, 114, 116, and 118 is substantially the same as the threaded surface 52 described above and shown in FIG. 5. Plumb adjusters 102, 104, 106, and 108 are substantially the same as the plumb adjuster 48 described above and shown in FIGS. 6-8. Plumb adjusters 102, 104, 106, and 108 engage threaded surfaces 112, 114, 116, and 118, respectively, in the same manner described above with respect to plumb adjuster 48 and threaded surface 52 as shown in FIGS. 9-12. Plumb adjuster 102 and threaded surface 112 are located at an upper left-hand corner of rear wall 110, when viewing the rear of the electrical enclosure 100 as shown in FIG. 13, plumb adjuster 104 and threaded surface 114 are located at an upper right-hand corner of rear wall 110, plumb adjuster 106 and threaded surface 116 are located at a lower left-hand corner of rear wall 110, and plumb adjuster 108 and threaded surface 118 are located at a lower right-hand corner of rear wall 110. Fasteners (not shown) may extend through the plumb adjusters 102, 104, 106, and 108 and engage a surface (not shown) behind the rear wall 110 to mount the electrical enclosure 100 to the surface in substantially the same manner as described above with respect to electrical enclosure 10.

Electrical enclosure 100 may be installed in substantially the same manner as described above with respect to electrical enclosure 10. However, while electrical enclosure 10 only has two plumb adjusters 46 and 48 that can adjust the distance between the rear wall 14 and the surface 12 at the bottom corners of the electrical enclosure 10, electrical enclosure 100 has four plumb adjusters 102, 104, 106, and 108 that can adjust the distance between the rear wall 110 and the surface to which the electrical enclosure 100 is mounted at all four of the corners of the electrical enclosure 100. Electrical enclosure 10 may be better suited for use in outdoor applications than electrical enclosure 100 because mounting embosses 38 and 40 of electrical enclosure 10 may prevent water running down surface 12 from entering the enclosure through the openings in the mounting embosses 38 and 40. Electrical enclosure 100 may also be used outdoors, however, particularly if the engagement between plumb adjusters 102 and 104 and threaded surfaces 112 and 114 is sealed to prevent water ingress. Any of the mounting locations on electrical enclosures 10 and 100 may be sealed to prevent water ingress as desired.

### 3. General

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as”) provided with respect to certain embodiments is intended merely to better describe the invention and does not pose a limitation on the scope of the invention. No language in the description should be construed as indicating any non-claimed element essential to the practice of the invention.

The use of relative relational terms, such as first and second, top and bottom, and left and right, are used solely to distinguish one unit or action from another unit or action without necessarily requiring or implying any actual such relationship or order between such units or actions.

In addition, the recitation of ranges of values in this disclosure is merely intended to serve as a shorthand method of referring individually to each separate value falling within the range. Unless otherwise indicated, each individual value is incorporated into the disclosure as if it were individually recited herein.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

While the present invention has been described and illustrated hereinabove with reference to several exemplary embodiments, it should be understood that various modifications could be made to these embodiments without departing from the scope of the invention. Therefore, the present invention is not to be limited to the specific configurations or methodologies of the exemplary embodiments, except insofar as such limitations are included in the following claims.

What is claimed and desired to be secured by Letters Patent is as follows:

1. A plumb adjuster configured to plumb an electrical enclosure mounted to a vertical or nearly vertical surface, the electrical enclosure comprising a wall with an opening therethrough and a threaded surface adjacent the opening, the plumb adjuster comprising:
a side wall with a threaded outer surface that is configured to engage the threaded surface of the electrical enclosure, the side wall comprising a first end and a second end, the side wall defining a cavity accessible through a first opening at the first end, the first opening configured to receive the head of a fastener for mounting the electrical enclosure to the surface; and
an end wall coupled to the second end of the side wall, the end wall comprising an outer surface configured to engage the surface to which the electrical enclosure is mounted, the end wall comprising an inner surface configured to engage the head of the fastener, the end wall defining a second opening that extends through the end wall, the second opening configured to receive a shank of the fastener.

2. The plumb adjuster of claim 1, wherein the side wall is operable to rotate so that the engagement between the threaded outer surface of the side wall and the threaded surface of the electrical enclosure moves the end wall with respect to the wall of the electrical enclosure and adjusts the distance between the wall of the electrical enclosure and the surface to which the electrical enclosure is mounted.

3. The plumb adjuster of claim 1, wherein the outer surface of the end wall is convex.

4. The plumb adjuster of claim 1, wherein the threaded outer surface is formed as a multi-start thread.

5. The plumb adjuster of claim 1, further comprising a tool engagement portion formed as part of the side wall or coupled to the side wall adjacent the first end.

6. The plumb adjuster of claim 5, wherein the tool engagement portion is configured to be engaged by a socket or wrench for rotating the side wall.

7. The plumb adjuster of claim 1, wherein the end wall is formed integrally with the side wall.

8. The plumb adjuster of claim 1, wherein the second opening has a smaller diameter than the first opening.

9. An electrical enclosure configured for mounting to a vertical or nearly vertical surface, the electrical enclosure comprising:
an enclosure wall with an opening therethrough and a threaded surface adjacent the opening; and
a plumb adjuster comprising:
a side wall with a threaded outer surface that engages the threaded surface of the enclosure wall, the side wall comprising a first end and a second end, the side wall defining a cavity accessible through a first opening at the first end, the first opening configured to receive the head of a fastener for mounting the enclosure wall to the vertical or nearly vertical surface; and
an end wall coupled to the second end of the side wall, the end wall comprising an outer surface configured to engage the surface to which the enclosure wall is mounted, the end wall comprising an inner surface configured to engage the head of the fastener, the end wall defining a second opening that extends through the end wall, the second opening configured to receive a shank of the fastener.

10. The electrical enclosure of claim 9, wherein the side wall is operable to rotate so that the engagement between the threaded outer surface of the side wall and the threaded surface of the enclosure wall moves the end wall with respect to the enclosure wall and adjusts the distance between the enclosure wall and the surface to which the enclosure wall is mounted.

11. The electrical enclosure of claim 9, wherein the outer surface of the end wall is convex.

12. The electrical enclosure of claim 9, wherein the threaded outer surface is formed as a multi-start thread.

13. The electrical enclosure of claim 9, further comprising a tool engagement portion formed as part of the side wall or coupled to the side wall adjacent the first end.

14. The electrical enclosure of claim 13, wherein the tool engagement portion is configured to be engaged by a socket or wrench for rotating the side wall.

15. The electrical enclosure of claim 9, wherein the second opening has a smaller diameter than the first opening.

16. The electrical enclosure of claim 9, wherein the enclosure wall defines a second opening that is spaced from the opening of the enclosure wall, the second opening of the enclosure wall configured to receive a portion of a second fastener for mounting the enclosure wall to the vertical or nearly vertical surface, and wherein a thickness of the enclosure wall adjacent the second opening of the enclosure wall is substantially the same as a thickness of the end wall of the plumb adjuster.

17. A method of mounting an electrical enclosure to a vertical or nearly vertical surface, the electrical enclosure comprising an enclosure wall with an opening therethrough and a threaded surface adjacent the opening, and a plumb adjuster comprising a side wall with a threaded outer surface that engages the threaded surface of the enclosure wall, the side wall comprising a first end and a second end, the side wall defining a cavity accessible through a first opening at the first end, and an end wall coupled to the second end of the side wall, the end wall comprising an outer surface and an inner surface, the end wall defining a second opening that extends through the end wall, the method comprising:
engaging the outer surface of the end wall with the vertical or nearly vertical surface;
rotating the plumb adjuster to move the end wall with respect to the enclosure wall and adjust the distance between the enclosure wall and the vertical or nearly vertical surface until the enclosure wall is substantially plumb or vertical;
inserting a fastener through the first opening of the plumb adjuster;
inserting a shank of the fastener through the second opening of the plumb adjuster; and
engaging the shank of the fastener with the vertical or nearly vertical surface to mount the enclosure wall to the vertical or nearly vertical surface.

18. The method of claim 17, further comprising performing the following steps prior to engaging the shank of the fastener with the vertical or nearly vertical surface:
inserting a second fastener through a second opening of the enclosure wall, the second opening of the enclosure wall being vertically spaced relative to the opening of the enclosure wall; and
engaging the second fastener with the vertical or nearly vertical surface to mount the enclosure wall to the vertical or nearly vertical surface so that a portion of the enclosure wall adjacent the second opening of the enclosure wall abuts the vertical or nearly vertical surface.

19. The method of claim 17, wherein the shank of the fastener is engaged with the vertical or nearly vertical surface until a head of the fastener engages the inner surface of the end wall.

20. The method of claim 17, further comprising, prior to rotating the plumb adjuster, engaging a tool with a tool engagement portion of the plumb adjuster.
